(19) United States
(12) Patent Application Publication
(10) Pub. No.: US 2026/0217087 A1
(43) Pub. Date: Jul. 30, 2026

(54) HEAT EXCHANGE DEVICE

(71) Applicant: AISAN KOGYO KABUSHIKI KAISHA, Obu-shi, Aichi (JP)

(72) Inventors: Makoto NAKAGAWA, Nagoya-shi (JP); Tomonori NAGASE, Chita-gun (JP); Yoichi NAKAO, Toyokawa-shi (JP)

(73) Assignee: AISAN KOGYO KABUSHIKI KAISHA, Obu-shi, Aichi (JP)

(21) Appl. No.: 19/148,617

(22) PCT Filed: Nov. 27, 2023
(86) PCT No.: PCT/JP2023/042313

§ 371 Date: Jul. 16, 2025

(30) Foreign Application Priority Data
Feb. 16, 2023 (JP) 2023-022068

(51) Int. Cl. B60H 1/00; B60H 1/22

(52) U.S. Cl. CPC B60H 1/00899; B60H 1/00278; B60H 1/00321; B60H 1/00385; B60H 2001/00949; B60H 2001/224; B60H 2001/2271

(57) ABSTRACT

This heat exchange device includes: a heater for heating a refrigerant flowing through a passage; a compressor for pumping the refrigerant; a temperature sensor for detecting the temperature of the refrigerant passing through the heater; and a controller for measuring a current and a voltage input to the heater, and controlling the heater and the compressor based on the refrigerant temperature, the current and the voltage. The controller: calculates a heater internal temperature from the current and the voltage; calculates a heater surface temperature from the heater internal temperature and a heater input power; calculates a temperature difference between the heater surface temperature and a refrigerant target temperature; calculates a target heater surface temperature from the temperature difference and the refrigerant temperature; and controls the heater input power or the refrigerant flow rate due to the compressor such that the heater surface temperature becomes the target heater surface temperature.

### TECHNICAL FIELD

The technique disclosed in this description relates to a heat exchange device for exchanging heat between a fluid that flows through a path and a heat exchanging unit.

### BACKGROUND ART

A conventional example of the above-mentioned technique is known as the technique described in Patent Document listed below. This technique relates to a vehicle heater for heating a medium, which is composed of a heat conductor layer that generates heat and a sensor layer allocated to the surface of the heat conductor layer to detect the temperature.

### RELATED ART DOCUMENTS

### Patent Documents

Patent Document 1: Japanese Patent No. 6171258

### SUMMARY OF INVENTION

### Problems to be Solved by the Invention

However, in the vehicle heater disclosed in Patent Document 1, the sensor layer is allocated on the surface of the heat conductor layer and the sensor layer is made of expensive ceramic material, so that the configuration of the vehicle heater would be complicated and high-cost. Further, since the surface of the heat conductor layer is covered with the ceramic material whose heat conduction is low, the temperature of the heat conductor layer easily rises, making it difficult for the vehicle heater to adjust the temperature of a medium.

The present disclosure has been made to address the above problems and has a purpose to provide a heat exchange device that includes a compact and low-cost heat exchanging unit for exchanging heat with a fluid, and can easily adjust the temperature of the fluid.

### Means of Solving the Problems

(1) To achieve the above purpose, one aspect of the disclosure provides a heat exchange device comprising: a heat exchanging unit that electrically operates to exchange heat with a fluid flowing through a path; a fluid pressure-feeding unit that electrically operates to pressure-feed the fluid to the path; a fluid temperature detecting unit to detect a temperature of the fluid passing through the heat exchanging unit; a current and voltage measuring unit to measure a current and a voltage that are input to the heat exchanging unit; and a control unit to control the heat exchanging unit and the fluid pressure-feeding unit based on the detected temperature, and the measured current and the measured voltage, wherein the control unit (I) calculates an internal temperature of the heat exchanging unit based on the measured current and the measured voltage, (II) calculates a surface temperature of the heat exchanging unit from the calculated internal temperature and an input power to the heat exchanging unit; (III) calculates a temperature difference between the calculated surface temperature and a target temperature of the fluid; (IV) calculates a target surface temperature of the heat exchanging unit from the calculated temperature difference and the detected temperature of the fluid, and (V) controls the input power to the heat exchanging unit or a flow rate of the fluid by the fluid pressure-feeding unit so that the calculated surface temperature becomes the target surface temperature.

According to the above-described configuration (1), the control unit controls the input power to the heat exchanging unit or the flow rate of the fluid fed by the fluid pressure-feeding unit so that the calculated surface temperature of the heat exchanging unit becomes the calculated target surface temperature, that is, controls the heat flux (the heat transfer amount per unit area). Thus, this configuration can provide the same heat transfer amount without enlarging the area of the heat exchanging unit.

(2) To achieve the above purpose, in the above-described configuration (1), preferably, the control unit calculates a resistance of the heat exchanging unit based on the measured current and the measured voltage, and calculates the internal temperature from the calculated resistance.

According to the above-described configuration (2), in addition to the operations of the foregoing configuration (1), it is possible to measure the internal temperature of the heat exchanging unit without using a temperature sensor.

(3) To achieve the above purpose, in the above-described configuration (1) or (2), preferably, the target temperature of the fluid is a boiling temperature of the fluid.

According to the above-described configuration (3), in addition to the operations of the foregoing configuration (1) or (2), the boiling temperature, which is the maximum temperature of the fluid, is set as the target temperature.

(4) To achieve the above purpose, in the above-described configuration (3), preferably, the fluid is a refrigerant, and the control unit calculates a heat flux of the heat exchanging unit, estimates a concentration of the refrigerant and the boiling temperature from the calculated heat flux and the calculated surface temperature, and corrects the target temperature of the refrigerant from the estimated concentration and the estimated boiling temperature.

According to the above-described configuration (4), in addition to the operations of the foregoing configuration (3), the boiling temperature of the refrigerant changes depending on its concentration. The control unit estimates the concentration and the boiling temperature of the refrigerant from the heat flux and the surface temperature, which are calculated separately, and corrects the target temperature of the refrigerant. This configuration can more precisely calculate the temperature difference between the surface temperature and the target temperature.

### Effects of the Invention

According to the above-described configuration (1), the heat exchanging unit for exchanging heat with a fluid can be made compact and low-cost, and the heat exchanging unit can easily adjust the temperature of a fluid.

According to the above-described configuration (2), in addition to the effects of the foregoing configuration (1), the configuration of the heat exchange device, which does not require a temperature sensor, can be simplified accordingly.

According to the above-described configuration (3), in addition to the effects of the foregoing configuration (1) or (2), the heat exchanging unit can function to a maximum extent for a fluid.

According to the above-described configuration (4), in addition to the effects of the foregoing configuration (3), it is possible to more precisely calculate the surface temperature of the heat exchanging unit, and therefore more accurately control the input power to the heat exchanging unit or the flow rate of the fluid, thereby enabling further size reduction of the heat exchange device.

### BRIEF DESCRIPTION OF THE DRAWINGS

FIG. 1 is a block diagram schematically showing a heat management system in a first embodiment, which will be mounted in an electric vehicle.

FIG. 2 is a flowchart showing contents of a heater control in the first embodiment.

FIG. 3 is a heater internal temperature map which is used to determine a heater internal temperature with respect to a heater resistance in the first embodiment.

FIG. 4 is a table showing one example of heater conductivity of various kinds of materials in the first embodiment.

FIG. 5 is a conceptual diagram showing one example of an image of a temperature difference between the heater internal temperature and the heater surface temperature in the first embodiment.

FIG. 6 is a graph showing the relationship of overheat degree, heat flux, refrigerant temperature, and target heater surface temperature.

FIG. 7 is an explanatory diagram to explain the effects of the first embodiment compared with a conventional case.

FIG. 8 is a graph showing differences in heater control contents in a second embodiment compared with the first embodiment.

### MODE FOR CARRYING OUT THE INVENTION

A detailed description of one embodiment of a heat exchange device, which is embodied in a heat management system to be mounted in an electric vehicle, will now be given referring to the accompanying drawings.

### First Embodiment

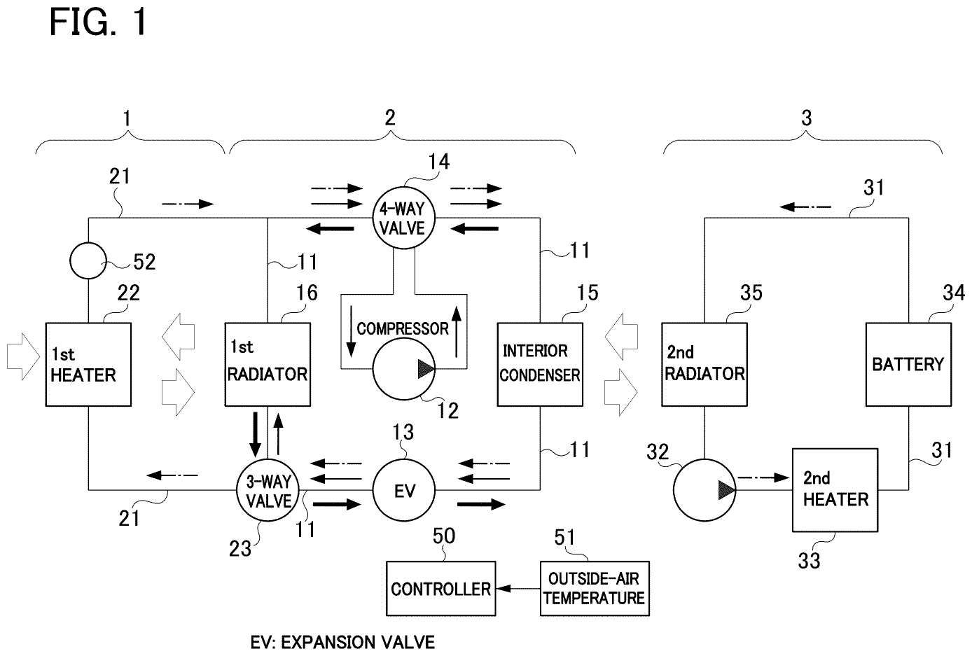

A first embodiment of a heat exchange device will be described in detail with reference to FIGS. 1 to 7.

### (Configuration of Heat Management System)

FIG. 1 is a block diagram schematically showing a heat management system in this embodiment, which is mounted in an electric vehicle. As shown in FIG. 1, this system is constituted of a heater circuit 1, a heat pump circuit 2, and a powertrain cooling circuit 3. In FIG. 1, thick arrows indicate the flow of a medium during cooling, dot-dashed arrows indicate the flow of a medium during heating when the atmosphere (outside air) is less than 0° C., dashed arrows indicate the flow of a medium during heating when the outside air is 0° C. or higher, and solid arrows indicate the flow of a medium between a compressor 12 and a 4-way valve 14. In this embodiment, a predetermined refrigerant is used, as one example of the “fluid”, in the heater circuit 1 and the heat pump circuit 2, and a coolant, or cooling water is used, as one example of the “fluid”, in the powertrain cooling circuit 3.

### (Heat Pump Circuit)

The heat pump circuit 2 in the present embodiment includes a first circulation path 11 through which a refrigerant circulates. In the first circulation path 11, the compressor 12, which is electrically driven, is placed to compress the refrigerant, and an expansion valve 13, which is electrically driven, is placed to expand the refrigerant. The compressor 12 is provided in the first circulation path 11 via the 4-way valve 14, which is electrically driven. The 4-way valve 14 is provided to switch the flowing direction of the refrigerant in the compressor 12. The 4-way valve 14 and the compressor 12 are configured to electrically operate to pressure-feed the refrigerant to the first circulation path 11 (the path) and correspond to one example of a “fluid pressure-feeding unit” of the disclosure.

In the first circulation path 11, an interior condenser 15 for releasing heat into the air in a vehicle interior is placed between the compressor 12 and the expansion valve 13. Further, in the first circulation path 11, a first radiator 16 for absorbing heat from the atmosphere (outside air) is placed between the compressor 12 and the expansion valve 13, in an opposite position to the position of the interior condenser 15.

### (Heater Circuit)

In the present embodiment, the heater circuit 1 is placed on the atmosphere side of the heat pump circuit 2. This heater circuit 1 includes a first bypass path 21 that bypasses the first radiator 16 in the first circulation path 11. In the first bypass path 21, a first heater 22, which is electrically operated, is placed to heat the refrigerant flowing through the first bypass path 21. The first heater 22 is configured to electrically operate to exchange heat with the refrigerant (the fluid) that flows through the first circulation path 11 (the path) and corresponds to one example of a “heat exchanging unit” of the disclosure.

In the present embodiment, in order to switch the flow of refrigerant between the first circulation path 11 and the first bypass path 21, a 3-way valve 23, which is electrically driven, is placed at a junction between an upstream part of the first circulation path 11 relative to the first radiator 16 in the flowing direction during heating and the first bypass path 21. This 3-way valve 23, at an opening degree of 0°, connects a part of the first circulation path 11 on the expansion valve 13 side and a part of the first circulation path 11 on the first radiator 16 side. The 3-way valve 23, at an opening degree of 90°, connects the part of the first circulation path 11 on the expansion valve 13 side and a part of the first bypass path 21 on the first heater 22 side.

### (Powertrain Cooling Circuit)

The powertrain cooling circuit 3 in the present embodiment includes a second circulation path 31 through which a coolant circulates. In this path 31, a pump 32, which is electrically driven, is placed most upstream, and a second heater 33, which is electrically operated, a battery 34, and a second radiator 35 are arranged in order. In this powertrain cooling circuit 3, at low temperatures, the coolant discharged from the pump 32 is heated by the second heater 33 up to 0° and then flows to the battery 34, so that the battery 34 is heated by heat exchange with the coolant. After warm-up, the second heater 33 is stopped, and the heat of the coolant discharged from the pump 32 is released to the outside of a vehicle through the second radiator 35, and this coolant then flows to the battery 34, cooling the battery 34. The second radiator 35 absorbs heat from the air inside the vehicle, thereby cooling the vehicle interior.

### (Electrical Configuration)

Next, the electrical configuration will be described. As shown in FIG. 1, this system further includes a controller 50 used for control, an outside-air temperature sensor 51 for detecting the temperature of outside air (outside air temperature) THA, and a refrigerant temperature sensor 52 for detecting the temperature of the refrigerant (the refrigerant temperature) THR that flows through the first bypass path 21 directly downstream of the first heater 22 in the heater circuit 1. The refrigerant temperature sensor 52 is configured to detect the temperature of the refrigerant passing through the first heater 22 and corresponds to one example of a “fluid temperature detecting unit” of the disclosure. The controller 50 is configured to control the 3-way valve 23, 4-way valve 14, compressor 12, expansion valve 13, first heater 22, pump 32, and second heater 33, that is, control the heat management system, based on detection results of the outside air temperature and others.

Furthermore, the controller 50 is configured to control the first heater 22, compressor 12, and 4-way valve 14 based on the detected refrigerant temperature THR and others and corresponds to one example of a “control unit” of the disclosure. The controller 50 is also configured to measure the current and the voltage, which are input to the first heater 22, in controlling the first heater 22, and corresponds to one example of a “current and voltage measuring unit” of the disclosure. Specifically, the heat management system in this embodiment includes a “heat exchange device” of the disclosure, composed of the first heater 22, compressor 12, 4-way valve 14, refrigerant temperature sensor 52, and controller 50.

### (Operations of Heat Management System)

According to the configuration of the heat management system in the present embodiment described above, the heat pump circuit 2 is configured such that, in the first circulation path 11 through which the refrigerant circulates, the interior condenser 15 that releases heat into the air inside the vehicle is placed, on one side, between the compressor 12 and the expansion valve 13, and the first radiator 16 (the first evaporator) that absorbs heat from the outside air is placed on the opposite side (the atmosphere side) to the position of the interior condenser 15, between the compressor 12 and the expansion valve 13. Here, the heat pump circuit 2 can be activated when the refrigerant is heated to a predetermined temperature (e.g., 0° C.).

In the configuration in the present embodiment, in the first circulation path 11, the first heater 22 is placed in the first bypass path 21 detouring around the first radiator 16 and heats the refrigerant flowing through this first bypass path 21. The first heater 22 is thus located on the side close to the first radiator 16 that absorbs heat from the atmosphere. Accordingly, under extremely low atmosphere temperatures, when the refrigerant passing through the first heater 22 is heated to nearly 0° C., the heat pump circuit 2 can be activated, allowing this heated refrigerant to circulate to the interior condenser 15 via the first bypass path 21 and the first circulation path 11. Specifically, the vehicle interior can be heated by the heat released from the interior condenser 15 into the vehicle interior air. Therefore, there is no need to heat the refrigerant to a high temperature (e.g., 60 to 80° C.) as in the conventional case, and hence the first heater 22 does not need to have a high heat resistance and a wider area. For this reason, the first heater 22 that is low-cost, compact, and lightweight can be achieved and further the heat management system can be reduced in size, weight, and cost.

According to the configuration in the present embodiment, in the heat pump circuit 2, the flowing direction of the refrigerant in the first circulation path 11 is switched between the forward direction and the reverse direction by the 4-way valve 14, thereby switching the flowing direction of the refrigerant in the compressor 12 and further the flowing direction of the refrigerant in the expansion valve 13. The operations of the compressor 12 and the expansion valve 13 switch from the function of releasing heat from the interior condenser 15 into the air (the heating) to the opposing, cooling function. Therefore, this heat management system can perform both the heating function and the cooling function.

### (Heat Exchange Device)

In the heat exchange device in the present embodiment, to achieve a low-cost and compact first heater 22, the controller 50 is configured to control the first heater 22 by the following heater control. Here, the heater control of the first heater 22 is explained as one example, but the second heater 33 can also be controlled in the same manner.

### (Heater Control)

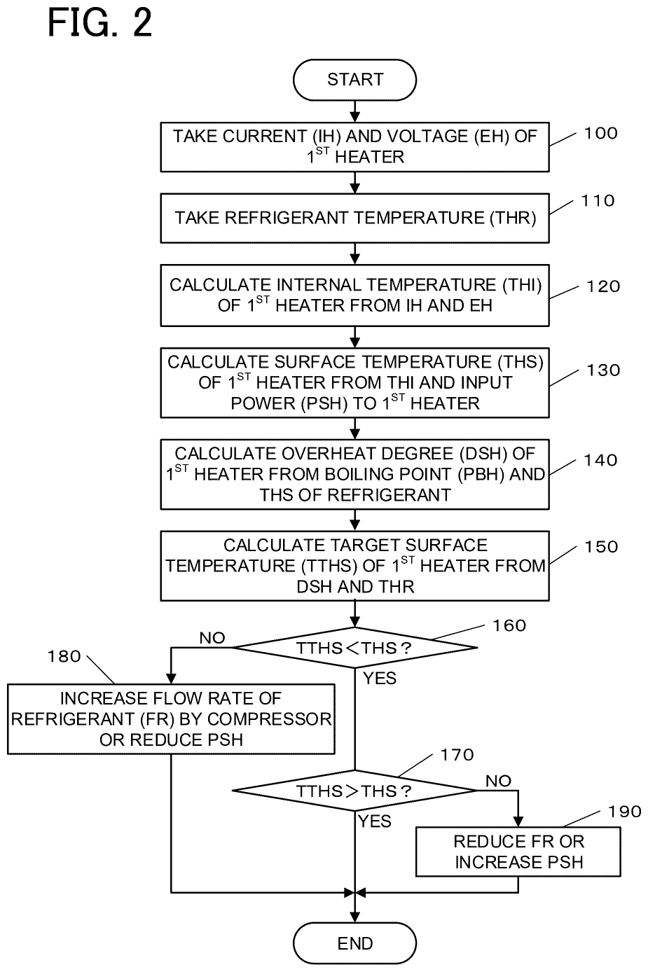

FIG. 2 is a flowchart showing the contents of the heater control. When the processing enters this routine, the controller 50 takes the current IH (heater current) and the voltage EH (heater voltage) of the first heater 22 in step 100. The controller 50 takes these heater current IH and heater voltage EH from command values issued to control energization of the first heater 22.

In step 110, the controller 50 then takes a refrigerant temperature THR. The controller 50 takes this refrigerant temperature THR based on a detection result of the refrigerant temperature sensor 52.

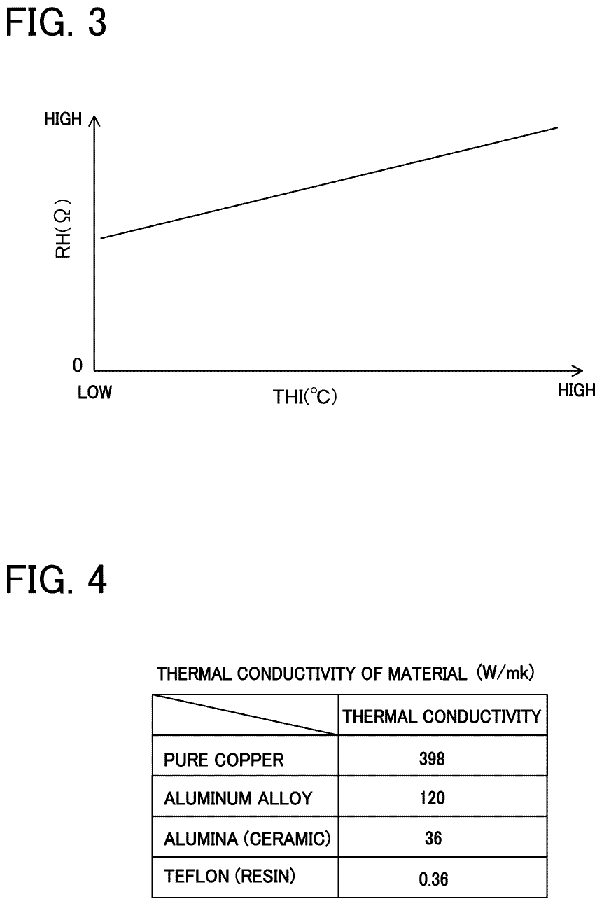

In step 120, subsequently, the controller 50 calculates an internal temperature (a heater internal temperature) THI of the first heater 22 from the taken heater current IH and heater voltage EH. Here, the controller 50 can calculate a resistance (a heater resistance) RH of the first heater 22 based on the measured heater current IH and heater voltage EH, and calculate the heater internal temperature THI from the calculated heater resistance RH. For example, the controller 50 can obtain the heater internal temperature THI with respect to the heater resistance RH by referring to a heater internal temperature map as shown in FIG. 3. This heater resistance RH can be obtained from the relationship between the heater current IH and the heater voltage EH. The heater internal temperature THI corresponds to one example of an “internal temperature” of the disclosure.

In step 130, the controller 50 then calculates a surface temperature (a heater surface temperature) THS of the first heater 22 from the heater internal temperature THI and an input power (a heater input power) PSH supplied to the first heater 22. This heater surface temperature THS can be obtained from the relationship in the following equation (F1):

$$PSH / AH = ( THI - THS ) * λ / σ \qquad ( F 1 )$$

where AH indicates the area of the first heater 22, λ indicates the thermal conductivity of the material that forms the first heater 22, and σ indicates the thickness of the first heater 22. Further, PSH/AH is a heat flux HF (W/cm²) that represents the heat transfer amount per unit area of the first heater 22. FIG. 4 is a table showing one example of the thermal conductivity of various kinds of materials. In the present embodiment, for example, aluminum alloy is used as the base material of the first heater 22. The heater input power PSH can be obtained from the heater current IH and the heater voltage EH.

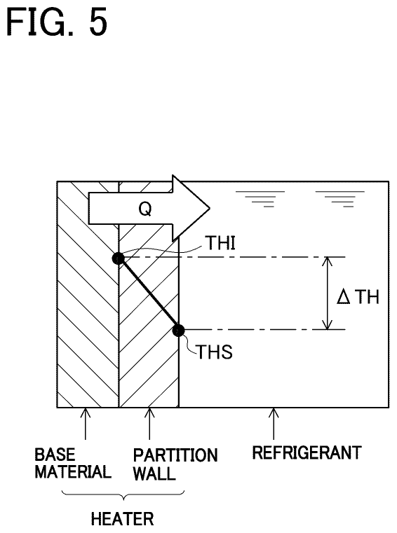

FIG. 5 is a conceptual diagram showing one example of an image of a temperature difference ΔTH between the heater internal temperature THI and the heater surface temperature THS. As shown in FIG. 5, the first heater 22 is configured such that a heating base material is covered with a partition wall, and the partition wall is exposed to the refrigerant. The heater internal temperature THI corresponds to the surface temperature of the base material, and the heater surface temperature THS corresponds to the surface temperature of the partition wall. When the base material is heated to the heater internal temperature THI and a predetermined heat transfer amount Q is transmitted to the partition wall and the refrigerant, the surface of the partition wall becomes the heater surface temperature THS. A difference between the heater internal temperature THI and the heater surface temperature THS is the temperature difference ΔTH. Here, the heat transfer amount Q corresponds to the heater input power PSH.

In step 140, the controller 50 subsequently calculates an overheat degree (a heater overheat degree) DSH of the first heater 22 from a boiling temperature (a refrigerant boiling point) PBH of the refrigerant and the heater surface temperature THS. Here, the refrigerant boiling point PBH corresponds to one example of a “target temperature” related to the refrigerant in this disclosure. The heater overheat degree DSH corresponds to one example of a “temperature difference” between the heater surface temperature THS and the refrigerant boiling point PBH.

In step 150, the controller 50 then calculates a target surface temperature (a target heater surface temperature) TTHS of the first heater 22 from the heater overheat degree DSH and the refrigerant temperature THR.

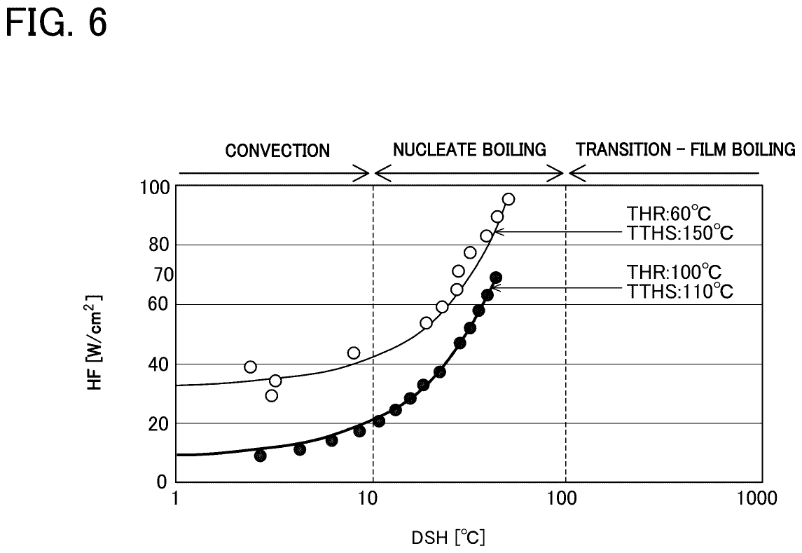

FIG. 6 is a graph showing the relationship of the heater overheat degree DSH, heat flux HF, refrigerant temperature THR, and target heater surface temperature TTHS, which are described above. In FIG. 6, a thick curve line and black circles indicate the case where the refrigerant temperature THR is 100° C. and the target heater surface temperature TTHS is 110° C., and a solid curve line and white circles indicate the case where the refrigerant temperature THR is 60° C. and the target heater surface temperature TTHS is 150° C. As shown in FIG. 6, it is revealed that the heat flux HF increases in a curved manner as the heater overheat degree DSH (the temperature difference between the heater surface temperature THS and the refrigerant boiling point PBH) increases. It is further revealed that the heat flux HF gently increases in a convection region, but sharply increases in a nuclear boiling region. In the case of a refrigerant temperature THR of 60° C., even if the refrigerant boils, a small amount of bubbles is generated. In the case of a refrigerant temperature THR of 100° C., the refrigerant violently boils, and the temperature cannot be raised due to counteraction.

In step 160, the controller 50 determines whether or not the target heater surface temperature TTHS is lower than the heater surface temperature. The controller 50 advances the processing to step 170 for an affirmative determination result or shifts the processing to step 180 for a negative determination result.

In step 170, the controller 50 determines whether or not the target heater surface temperature TTHS is higher than the heater surface temperature. The controller 50 temporarily terminates the subsequent processing for an affirmative determination result or shifts the processing to step 190 for a negative determination result.

In step 180, which follows step 160, the controller 50 increases a refrigerant flow rate FR by the compressor 12 or reduces the heater input power PSH, and temporarily terminates the subsequent processing.

On the other hand, in step 190, which follows step 170, the controller 50 reduces the refrigerant flow rate FR by the compressor 12 or increases the heater input power PSH, and temporarily terminates the subsequent processing.

According to the foregoing heater control, the controller 50 is configured to:
(1) calculate the heater internal temperature THI based on the measured heater current IH and heater voltage EH;
(2) calculate the heater surface temperature THS from the calculated heater internal temperature THI and the heater input power PSH;
(3) calculate the heater overheat degree DSH (the temperature difference) between the calculated heater surface temperature THS and the refrigerant boiling point PBH;
(4) calculate the target heater surface temperature TTHS from the calculated heater overheat degree DSH and the detected refrigerant temperature THR; and
(5) control the heater input power PSH or the refrigerant flow rate FR by the compressor 12 so that the calculated heater surface temperature THS becomes the calculated target heater surface temperature TTHS.

### (Operations and Effects of Heat Exchange Device)

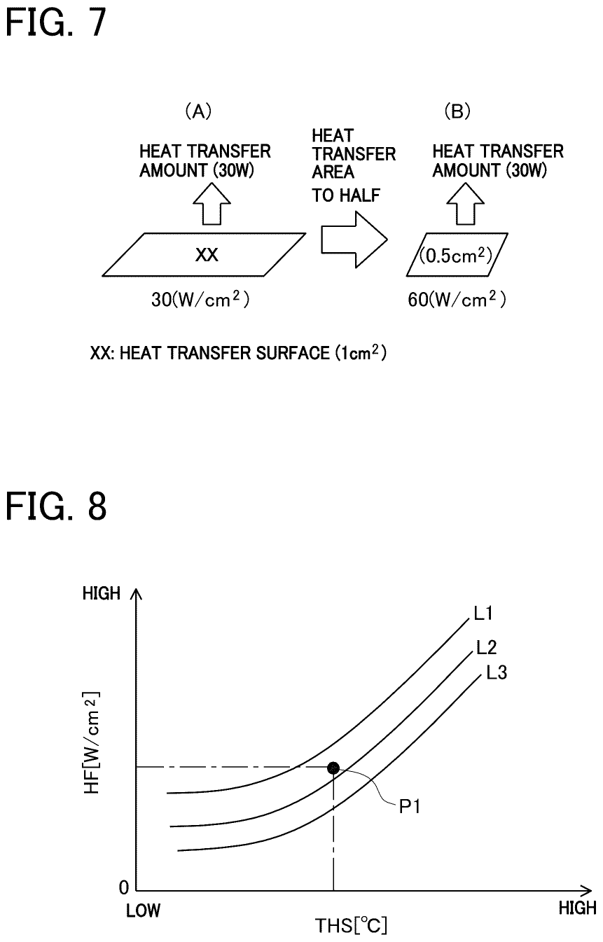

According to the configuration of the heat exchange device in the present embodiment described above, for the first heater 22, the controller 50 controls the heater input power PSH to the first heater 22 or the flow rate of the refrigerant through the compressor 12 so that the calculated heater surface temperature THS becomes the target heater surface temperature TTHS, that is, controls the heat flux HF (the heat transfer amount per unit area). This configuration can provide the same heat transfer amount Q without enlarging the area of the first heater 22. Specifically, as shown in FIG. 7, in a conventional case (A), the heat flux HF was controlled to 30 (W/cm²) in order to obtain a heat transfer amount Q of 30 (W) with the heater having a heat transfer area of 1 cm². In contrast, in the present embodiment (B), the heat flux HF is controlled to 60 (W/cm²) with the heater having a heat transfer area of 0.5 cm², so that a heat transfer amount Q of 30 (W) is obtained. Specifically, the present embodiment can reduce the heat transfer area of the heater to half in the conventional case to obtain the same heat transfer amount Q. Accordingly, the first heater 22 for exchanging heat with a refrigerant can be made compact and inexpensive. FIG. 7 is an explanatory diagram to explain the effects of the present embodiment compared to the conventional case.

According to the configuration of the present embodiment, the controller 50 calculates the heater resistance RH based on the measured heater current IH and the measured heater voltage EH, and calculates the heater internal temperature THI from the calculated heater resistance RH. Specifically, in the present embodiment, the heater internal temperature THI can be measured without the use of a temperature sensor. Consequently, the configuration of the heat exchange device, not requiring a temperature sensor, can be simplified accordingly.

According to the configuration of the present embodiment, the refrigerant boiling point PBH that is a maximum temperature of a refrigerant is set to a target refrigerant temperature TTHR. This allows the first heater 22 to function to a maximum extent for a refrigerant.

### Second Embodiment

Next, a second embodiment of the heat exchange device will be described in detail, referring to FIG. 8. In the following description, similar or identical components to those in the first embodiment are assigned the same reference signs and their details are omitted, and differences from the first embodiment are focused.

### (Heater Control)

The present embodiment differs from the first embodiment in the heater control. In the present embodiment, the controller 50 is configured to calculate the heat flux HF of the first heater 22, estimate a concentration (a refrigerant concentration) CR of a refrigerant and a refrigerant boiling point PBH from the calculated heat flux HF and the calculated heater surface temperature THS, and correct the target refrigerant temperature TTHR from the estimated refrigerant concentration CR and the estimated refrigerant boiling point PBH.

FIG. 8 is a graph showing differences in the contents of the heater control between the second embodiment and the first embodiment. As shown in FIG. 8, the heat flux HF increases in a curved manner as the heater surface temperature THS rises. In FIG. 8, a first curve line L1 indicates the characteristics when the refrigerant concentration CR is 50% and the refrigerant boiling point PBH is 60° C., a second curve line L2 indicates the characteristics when the refrigerant concentration CR is 40% and the refrigerant boiling point PBH is 60° C., and a third curve line L3 indicates the characteristics when the refrigerant concentration CR is 30% and the refrigerant boiling point PBH is 60° C. In FIG. 8, the refrigerant concentration CR at a measured value P1 is estimated to be 45% from the relationship between the heater surface temperature THS and the heat flux HF.

### (Operations and Effects of Heat Exchange Device)

According to the configuration of the heat exchange device in the present embodiment described above, the following operations and effects can be achieved in addition to the operations and effects in the first embodiment. In the present embodiment, specifically, the refrigerant boiling point PBH of the refrigerant also changes depending on the refrigerant concentration CR. The controller 50 estimates the refrigerant concentration CR and the refrigerant boiling point PBH from the calculated heat flux HF and the calculated heater surface temperature THS and, based on them, corrects the target refrigerant temperature TTHR. This configuration can more precisely calculate a temperature difference between the heater surface temperature THS and the target refrigerant temperature TTHR (the refrigerant boiling point PBH), and thus more precisely calculate the heater surface temperature THS of the first heater 22. This can more accurately control the heater input power PSH to the first heater 22 or the refrigerant flow rate FR, thereby enabling further size reduction of the first heater 22.

### Other Embodiments

The disclosure is not limited to each of the foregoing embodiments and may be embodied in other specific forms without departing from the essential characteristics thereof.

In each of the foregoing embodiments, the first heater 22 is used as a specific example of the heat exchanging unit. However, as alternatives, the second heater 33 or an electrically-driven cooler may be used as a specific example of the heat exchanging unit.

### INDUSTRIAL APPLICABILITY

The disclosure can be utilized in a heat management system which will be mounted in an electric vehicle.

### REFERENCE SIGNS LIST

11 First circulation path (Path)
22 First bypass path (Path)
12 Compressor (Fluid pressure-feeding unit)
22 First heater (Heat exchanging unit)
50 Controller (Control unit, Current and voltage measuring unit)
52 Refrigerant temperature sensor (Fluid temperature detecting unit)

1. A heat exchange device comprising:
a heat exchanging unit that electrically operates to exchange heat with a fluid flowing through a path;
a fluid pressure-feeding unit that electrically operates to pressure-feed the fluid to the path;
a fluid temperature detecting unit to detect a temperature of the fluid passing through the heat exchanging unit;
a current and voltage measuring unit to measure a current and a voltage that are input to the heat exchanging unit; and
a control unit to control the heat exchanging unit and the fluid pressure-feeding unit based on the detected temperature, and the measured current and the measured voltage,
wherein the control unit
(I) calculates an internal temperature of the heat exchanging unit based on the measured current and the measured voltage,
(II) calculates a surface temperature of the heat exchanging unit from the calculated internal temperature and an input power to the heat exchanging unit;
(III) calculates a temperature difference between the calculated surface temperature and a target temperature of the fluid;
(IV) calculates a target surface temperature of the heat exchanging unit from the calculated temperature difference and the detected temperature of the fluid, and
(V) controls the input power to the heat exchanging unit or a flow rate of the fluid by the fluid pressure-feeding unit so that the calculated surface temperature becomes the target surface temperature.

2. The heat exchange device according to claim 1, wherein the control unit calculates a resistance of the heat exchanging unit based on the measured current and the measured voltage, and calculates the internal temperature from the calculated resistance.

3. The heat exchange device according to claim 1, wherein the target temperature of the fluid is a boiling temperature of the fluid.

4. The heat exchange device according to claim 3, wherein
the fluid is a refrigerant, and
the control unit calculates a heat flux of the heat exchanging unit, estimates a concentration of the refrigerant and the boiling temperature from the calculated heat flux and the calculated surface temperature, and corrects the target temperature of the refrigerant from the estimated concentration and the estimated boiling temperature.

5. The heat exchange device according to claim 2, wherein the target temperature of the fluid is a boiling temperature of the fluid.

6. The heat exchange device according to claim 5, wherein the fluid is a refrigerant, and
the control unit calculates a heat flux of the heat exchanging unit, estimates a concentration of the refrigerant and the boiling temperature from the calculated heat flux and the calculated surface temperature, and corrects the target temperature of the refrigerant from the estimated concentration and the estimated boiling temperature.
